(19) United States
(12) Patent Application Publication
(10) Pub. No.: US 2019/0374959 A1
(43) Pub. Date: Dec. 12, 2019

(54) SHOWER HEAD

(71) Applicant: SINYU TECHNOLOGY (FUJIAN) CO., LTD., Zhangzhou, Fujian (CN)

(72) Inventor: Zhangjun YU, Zhangzhou, Fujian (CN)

(73) Assignee: SINYU TECHNOLOGY (FUJIAN) CO., LTD., Zhangzhou, Fujian (CN)

(21) Appl. No.: 16/487,418

(22) PCT Filed: Feb. 27, 2018
(86) PCT No.: PCT/CN2018/077422

§ 371 Date: Aug. 20, 2019

(30) Foreign Application Priority Data
Feb. 28, 2017 (CN) 201710114846.1

(51) Int. Cl. B05B 1/16; B05B 1/18

(52) U.S. Cl. CPC B05B 1/1636; B05B 1/18

(57) ABSTRACT

A shower head, including the following components arranged successively from top to bottom: an upper plate provided with water inlets, a water dispensing plate provided with water outflow openings, and a water outflow panel provided with water outflow nozzles, wherein the water dispensing plate is provided with an impeller, which is in rotatable connection with the water dispensing plate and intermittently blocks the water outflow openings by way of rotation, and the water outflow openings are arranged in one-to-one correspondence with the water outflow nozzles. The shower head has a simple structure, and the impeller intermittently blocks the water outflow openings, hereby forming a pulsed water flow at the water outflow openings and realizing a massage-like effect for users.

### CROSS-REFERENCE TO RELATED APPLICATIONS

The present disclosure claims the priority of the Chinese Patent Application No. 2017101148461, entitled “Shower Head”, filed with the Chinese Patent Office on Feb. 28, 2017, the content of which is incorporated herein by reference in its entirety.

### TECHNICAL FIELD

The present disclosure relates to the technical field of sanitary products, and in particular to a shower head.

### BACKGROUND ART

With the social advancement, the development of the economy and the continuous improvement of living standards, the requirements on sanitary products are also getting higher and higher.

In modern life, because of fast-paced lifestyle and highly intensive work, bathing is no longer a simple form of cleaning, but a way to release stress, get relaxed, and relieve fatigue.

Shower heads have become one of the indispensable items in the bath. Existing shower heads comprise handheld shower heads, overhead shower heads and the like. Traditional shower heads only have the function of discharging water and is simple in function, which is difficult to meet people's demands.

### SUMMARY

An object of the present disclosure is to overcome the defects existing in the prior art by providing a shower head for the purpose of solving the problems existing in the prior art.

In order to solve the problems mentioned above, the present disclosure provides a shower head, comprising the following components arranged successively from top to bottom: an upper plate provided with water inlets, a water dispensing plate provided with water outflow openings, and a water outflow panel provided with water outflow nozzles;

The water dispensing plate is provided with an impeller, which is in rotatable connection with the water dispensing plate and configured to intermittently block the water outflow openings by way of rotation;

The impeller is provided with a blocking piece for blocking the water outflow openings;

The blocking piece has a fan-shaped cross-section;

The impeller and the blocking piece are formed integrally; and

The water outflow openings are arranged in one-to-one correspondence with the water outflow nozzles.

As a further improvement of the technical solution described above, the water dispensing plate includes a bottom board, a first cylindrical side wall perpendicular to the bottom board, and a second cylindrical side wall arranged within the first cylindrical side wall;

The shaft axes of the first cylindrical side wall and the second cylindrical side wall are collinear with each other, and the first cylindrical side wall and the second cylindrical side wall are both in fixed connection with the bottom board;

The water outflow openings pass through the bottom board perpendicularly, and are arranged between the first cylindrical side wall and the second cylindrical side wall; and

The impeller is provided with a through hole having a circular cross-section, wherein the through hole is in rotatable connection and in clearance fit with the second cylindrical side wall.

As a further improvement of the technical solution described above, a plurality of blocking pieces are provided; and

The blocking pieces are spaced from each other and are distributed in the same plane.

As a further improvement of the technical solution described above, the plurality of blocking pieces is in an array distribution around the rotation axis of the impeller.

As a further improvement of the technical solution described above, the impeller is made of plastic by injection molding.

As a further improvement of the technical solution described above, the water inlets pass through the upper plate, and are not perpendicular to the cross-section of the upper plate.

As a further improvement of the technical solution described above, there are several groups of the water inlets.

As a further improvement of the technical solution described above, the several groups of the water inlets are in an array distribution around the rotation axis of the impeller.

As a further improvement of the technical solution described above, there are two water inlets in each group, and the two water inlets are inclined in the same direction.

As a further improvement of the technical solution described above, the two water inlets are distributed along a radial direction of the upper plate.

As a further improvement of the technical solution described above, there are a plurality of water outflow openings, which are in an array distribution about the rotation axis of the impeller.

As a further improvement of the technical solution described above, there are eight water outflow openings.

As a further improvement of the technical solution described above, the water outflow openings are distributed in the water dispensing plate at equal distance.

As a further improvement of the technical solution described above, the number of the water outflow nozzles is equal to that of the water outflow openings.

As a further improvement of the technical solution described above, the positions of the water outflow openings respectively correspond to the positions of the water outflow nozzles.

As a further improvement of the technical solution described above, the water outflow nozzle is provided with a plurality of water outlets.

As a further improvement of the technical solution described above, there are three water outlets.

As a further improvement of the technical solution described above, the distances between respectively adjacent water outlets on the same water outflow nozzle are equal to each other.

The present disclosure has the following beneficial effects: the present disclosure provides a shower head, comprising the following components arranged successively from top to bottom: an upper plate provided with water inlets, a water dispensing plate provided with water outflow openings, and a water outflow panel provided with water outflow nozzles. In the above, the water dispensing plate is provided with an impeller, which is in rotatable connection with the water dispensing plate and configured to intermittently block the water outflow openings by way of rotation. Moreover, the water outflow openings are arranged in one-to-one correspondence with the water outflow nozzles.

When the impeller is rotated by a certain angle, the impeller and the blocking pieces would block a water outflow opening, and water would not be able to flow out of the water outflow opening, after that the water outflow opening is blocked, and at this moment, no water flows out of the water outflow nozzle corresponding to the water outflow opening; and if the impeller and the blocking pieces are continued to rotate, the water outflow opening blocked by the impeller and the blocking pieces would not be blocked any more, water flowing in through the water inlets can now be discharged through the water outflow opening, and water can also flow out of the water outflow nozzle corresponding to the water outflow opening.

The impeller performs circling motion under the effect of water pressure, and the above process is repeated continuously, wherein the impeller intermittently blocks the water outflow openings, hereby forming a pulsed water flow at the water outflow openings from water passing through the shower head, and realizing a massage-like effect for users.

The shower head has a simple structure, and can meet requirements of people for massage and health care during bathing, and at the same time, people can fully relax during the bathing process. The shower head allows the user to be massaged when taking a shower, while ensuring the reliability and safety of the use, hereby achieving the effects of relaxing the muscles and promoting blood circulation, wherein the user can obtain more comfortable bathing and massage experience.

### BRIEF DESCRIPTION OF THE DRAWINGS

In order to more clearly describe the technical solutions in the embodiments of the present disclosure, the figures required to be used in the embodiments will be briefly introduced in the following contents. It shall be understood that the following figures merely show certain embodiments of the present disclosure, and thus should not be deemed as limiting the scope thereof, and for a person ordinarily skilled in the art, further relevant figures could be obtained according to these figures without inventive efforts.

FIG. 1 is an exploded view of a shower head according to an embodiment of the present disclosure;

FIG. 2 is a schematic view of an impeller according to an embodiment of the present disclosure;

FIG. 3 is a schematic view of a water dispensing plate according to an embodiment of the present disclosure;

FIG. 4 is a schematic view of the positional relationship between the blocking pieces and the water outflow openings, when the impeller is rotated to a first angle in an embodiment of the present disclosure;

FIG. 5 is a schematic view of the positional relationship between the blocking pieces and the water outflow openings, when the impeller is rotated to a second angle in an embodiment of the present disclosure; and

FIG. 6 is a schematic view of a water outflow panel according to an embodiment of the present disclosure.

### EXPLANATION OF MAIN ELEMENT SIGNS

100—upper plate; 110—water inlet; 200—water dispensing plate; 210—impeller; 211—blocking piece; 220—water outflow opening; 300—water outflow panel; 310—water outflow nozzle; 311—water outlet; 2001—bottom board; 2002—first cylindrical side wall; and 2003—second cylindrical side wall.

### DETAILED DESCRIPTION OF THE EMBODIMENTS

In the following contents, various embodiments of the present disclosure will be more comprehensively described. The present disclosure may be carried out in various embodiments, and adjustments and modifications are also allowed to be made therein. However, it should be understood that there is no intent to limit the various embodiments of the present disclosure to the specific embodiments disclosed herein, instead, the present disclosure should be construed as covering all adjustments, equivalents and/or alternatives that fall within the spirit and the scope of the various embodiments of the present disclosure.

In the following contents, terms “comprise” or “includable”, which may be used in the various embodiments of the present disclosure, indicate the presence of the disclosed function, operation or element, without limiting the increase of one or more functions, operations or elements. In addition, terms “comprise”, “have” and cognates thereof as used in the various embodiments of the present disclosure are only intended to indicate a specific feature, number, step, operation, element, assembly, or a combination of the foregoing, but should not be understood as firstly excluding the presence of one or more other features, numbers, steps, operations, elements, assemblies, or combinations of the foregoing, or excluding the possibility of increasing one or more features, numbers, steps, operations, elements, assemblies, or combinations of the foregoing.

In the various embodiments of the present disclosure, the expression “or” or “at least one of A or/and B” includes any or all combinations of the simultaneously listed characters. For example, the expression “A or B” or “at least one of A or/and B” may include A, may include B, or may include both A and B.

Expressions (such as “first”, “second” or the like) used in the various embodiments of the present disclosure may modify various constituent elements in the various embodiments, however, the corresponding constituent elements are not thus limited. For example, the above expressions do not limit the sequence and/or importance of the elements. The above expressions are only used for the purpose of distinguishing one element from other elements. For example, a first user device and a second user device indicate different user devices, although both are user devices. For example, without departing from the scope of the various embodiments of the present disclosure, a first element could be termed a second element, and a second element could also be termed a first element.

It should be noted that in the present disclosure, unless otherwise expressly specified and defined, terms such as “mount”, “connect”, and “fix” shall be construed in a broad sense. For example, it may be fixed connection, or detachable connection, or integrated connection; it may be mechanical connection, or electrical connection; or it may be direct connection, or indirect connection via an intermediate medium; or it may be inner communication between two elements. For a person ordinarily skilled in the art, the specific meanings of the above-mentioned terms in the present disclosure could be construed in accordance with specific circumstances.

In the present disclosure, it should be understood for a person ordinarily skilled in the art that terms indicating orientations or position relationships in the present disclosure show orientations or position relationships based on the figures, merely for the purpose of facilitating the description of the present disclosure and for simplifying the description, rather than indicating or implying that a specified device or element must be in a specific orientation, or be constructed and operated in a certain orientation, and therefore cannot be construed as limiting the present disclosure.

The terms used in the various embodiments of the present disclosure are only used for the purpose of describing specific embodiments, and are not intended to limit the various embodiments of the present disclosure. As used herein, a singular form is also intended to comprise plural form, unless it is clearly otherwise defined in the context. Unless otherwise defined, all terms (including technical terms and scientific terms) used herein have the same meaning as commonly understood by a person ordinarily skilled in the field, to which the various embodiments of the present disclosure relate. The terms (such as terms defined in a commonly used dictionary) should be interpreted as having the same meaning as the contextual meaning in the related technical field and should not be interpreted as having an idealized meaning or an overly formal meaning, unless clearly defined in the various embodiments of the present disclosure.

### Embodiment 1

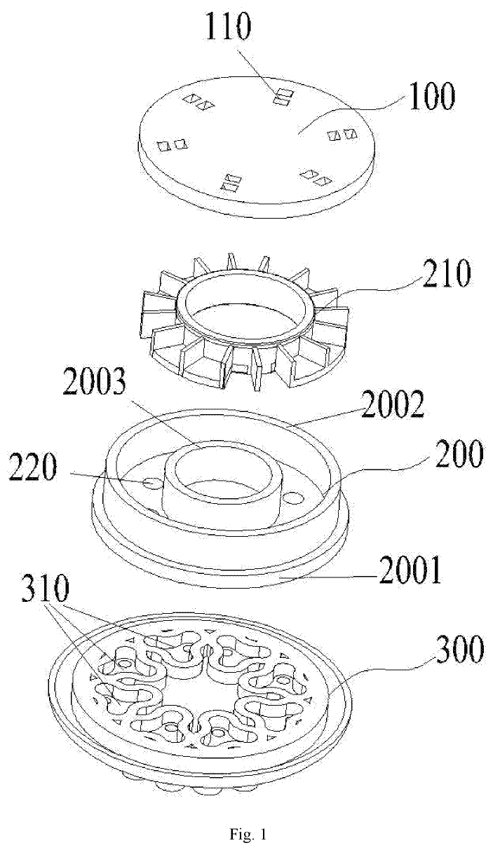

Referring to FIG. 1, a shower head is provided in the present embodiment, comprising: an upper plate 100, a water dispensing plate 200 and a water outflow panel 300, which are successively arranged from top to bottom.

In the above, the upper plate 100 is provided with water inlets 110. The water inlets 110 enable water to enter the shower head, and the water dispensing plate 200 is provided with water outflow openings 220. After entering the shower head through the water inlets 110, water then flows to the water outflow openings 220, and is discharged through the water outflow openings 220 afterwards.

In the present embodiment, the water dispensing plate 200 is further provided with an impeller 210, which is in rotatable connection with the water dispensing plate 200. After that water flows to the water dispensing plate 200 from the water inlets 110, the impeller 210 on the water dispensing plate 200 is rotated under the effect of water pressure. In the present embodiment, the impeller 210 can intermittently block the water outflow openings 220 on the water dispensing plate 200 by way of rotation, such that water can be intermittently discharged through the water outflow openings 220.

The water outflow panel 300 is provided with water outflow nozzles 310. After passing through the water outflow openings 220, water finally flows out of the shower head through the water outflow nozzles 310 for use by the user.

In the present embodiment, the water outflow openings 220 are arranged in one-to-one correspondence with the water outflow nozzles 310. The term “one-to-one correspondence” here specifically means that the number of the water outflow openings 220 is equal to that of the water outflow nozzles 310, and the positions of the water outflow openings 220 respectively correspond to the positions of the water outflow nozzles 310. Water flowing out from the water outflow openings 220 will flow into the corresponding water outflow nozzles 310, and then be discharged from the shower head through the water outflow nozzles 310.

When the impeller 210 is rotated by a certain angle, the impeller 210 would block a water outflow opening 220, and after being blocked, the water outflow opening 220 would be closed and water could not flow out of the water outflow opening 220, and at this moment, no water flows out of the water outflow nozzle 310 corresponding to the water outflow opening 220; and if the impeller 210 is continued to rotate, the water outflow opening 220 blocked by the impeller 210 would not be blocked any more, and now the water outflow opening 220 is opened, water flowing in through the water inlets 110 can now be discharged through the water outflow opening 220, and water can also flow out of the water outflow nozzle 310 corresponding to the water outflow opening 220.

The impeller 210 performs circling motion under the effect of water pressure, and the above process is repeated continuously, wherein the impeller 210 intermittently blocks the water outflow openings 220, hereby forming a pulsed water flow at the water outflow openings 220 from water passing through the shower head, and realizing a massage-like effect for users.

The shower head can meet requirements of people for massage and health care during bathing, and at the same time, people can fully relax during the bathing process. The shower head allows the user to be massaged when taking a shower, while ensuring the reliability and safety of the use, hereby achieving the effects of relaxing the muscles and promoting blood circulation, wherein the user can obtain more comfortable bathing and massage experience.

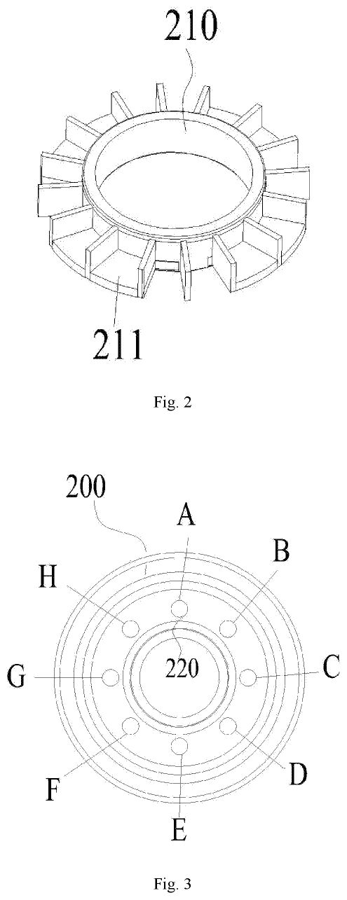

As shown in FIG. 2, to make the impeller 210 better block the water outflow openings 220 during the rotation, the impeller 210 can be provided with a blocking pieces 211, by means of which the water outflow openings 220 can be blocked, such that water cannot flow out of the water outflow openings 220. Herein, the blocking pieces 211 have a fan-shaped cross-section.

Since the impeller 210 is rotated under the effect of water pressure, the specific gravity of the material, when selecting the material for the manufacture of the impeller 210, should be selected as small as possible, such that the weight of the impeller 210 can be small. The inertia of the impeller 210 is small, and can easily be rotated under the effect of water pressure.

The impeller 210 and the blocking pieces 211 can be manufactured by way of integral molding. In the present embodiment, the impeller 210 can be made of plastic with the process of injection molding. In other specific embodiments, the impeller 210 may also be made of other materials.

In the present embodiment, there could be a plurality of blocking pieces 211. These blocking pieces 211 are arranged on the impeller 210 with an interval therebetween and are distributed in the same plane. Moreover, the impeller 210 is provided with a through hole having a circular cross-section.

As shown in FIG. 1, in the present embodiment, to be in cooperation with the impeller 210, the water dispensing plate 200 includes a bottom board 2001, a first cylindrical side wall 2002 and a second cylindrical side wall 2003. Herein, the first cylindrical side wall 2002 is perpendicular to the bottom board, and the second cylindrical side wall 2003 is arranged in the interior of the first cylindrical side wall 2002.

Specifically, the shaft axes of the first cylindrical side wall 2002 and the second cylindrical side wall 2003 are collinear with each other, and the first cylindrical side wall 2002 and the second cylindrical side wall 2003 are both in fixed connection with the bottom board 2001. The water outflow openings 220 pass through the bottom board 2001 perpendicularly, and are arranged between the first cylindrical side wall 2002 and the second cylindrical side wall 2003. The through hole on the impeller 210 is in rotatable connection and in clearance fit with the second cylindrical side wall 2003.

In the present embodiment, the water inlets 110 pass through the upper plate 100, and are not perpendicular to the cross-section of the upper plate 100. When entering the shower head, water would flow in a direction in which the water inlets 110 are arranged.

In order to ensure sufficient water inflow and water pressure, a plurality of water inlets 110 may be provided on the upper plate 100, and these water inlets 110 may be distributed on the upper plate 100 in an array distribution about the rotation axis of the impeller 210.

In the present embodiment, the upper plate 100 can be provided with 12 water inlets 110. In other specific embodiments, the number of the water inlets 110 may also be configured according to actual situations, specifically, 8, 10 or 16 water inlets may be arranged.

In the present embodiment, the water dispensing plate 200 may be provided with a plurality of water outflow openings 220, and these water outflow openings 220 can be arranged on the water dispensing plate 200 in an array distribution about the rotation axis of the impeller 210. As the water outflow openings 220 are arranged in one-to-one correspondence with the water outflow nozzles 310, the number and the distribution mode of the water outflow nozzles 310 are also identical with that of the water outflow openings 220. Herein, the number of the water outflow openings 220 and the number of the water outflow nozzles 310 may be configured according to actual situations.

As shown in FIG. 3, in the present embodiment, 8 water outflow openings 220 can be provided, and they are distributed on the water dispensing plate 200 with an equal distance therebetween, wherein the included angle between adjacent water outflow openings 220 is 45°. Correspondingly, provided are also 8 water outflow nozzles 310.

In the present embodiment, the blocking pieces 211 on the impeller 210 can be arranged in an array distribution about the rotation axis of the impeller 210.

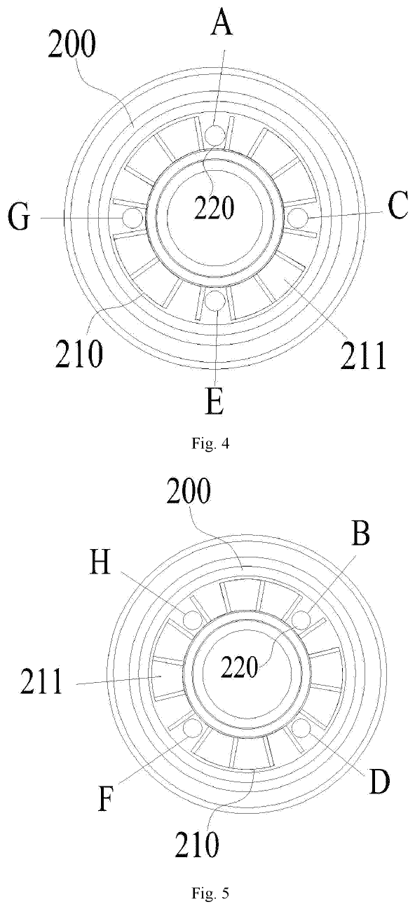

Referring to FIG. 4, when the impeller 210 is rotated to a first angle, the blocking pieces 211 on the impeller 210 block water outflow openings 220 at the four positions, viz. B-, D-, F-, and H-position, now the four water outflow openings 220 are closed and no water flow out of these water outflow openings; other water outflow openings 220 located at the four positions, viz. A-, C-, E-, and G-position in horizontal and vertical directions, are open, and water flowing in through the water inlets 110 flows through these water outflow openings 220 to corresponding water outflow nozzles 310.

Referring to FIG. 5, when the impeller 210 is continued to rotate till a second angle, the blocking pieces 211 on the impeller 210 block the water outflow openings 220 at the four positions, viz. the A-, C-, E-, and G-position, and at this moment, the four water outflow openings 220 are closed; while the rest water outflow openings 220 at the four positions, i.e. the B-, D-, F-, and H-position, are open.

The impeller 210 performs circling motion under the effect of water pressure, and the above process is repeated continuously, and each of the water outflow openings 220 is open and closed intermittently, hereby realizing an intermittent and pulsed water flow at the water outflow openings 220.

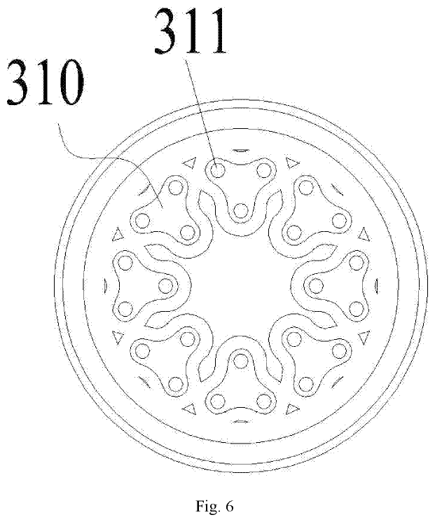

As shown in FIG. 6, moreover, in the present embodiment, the water outflow nozzle 310 is provided with a plurality of water outlets 311, specifically, through which water is discharged from the shower head. Specifically, the water outflow nozzle 310 can be provided with 3 water outlets 311. Herein, on the same water outflow nozzle 310, the distances between adjacent water outlets 311 are identical. In other specific embodiments, the number and the distribution mode of the water outlets 311 can be configured according to actual demands.

It could be understood for a person skilled in the art that the figures are merely schematic views for a preferable implementation scenario, and the modules or the flow path in the figures are not necessarily required to implement the present disclosure.

It could be understood for a person skilled in the art that modules in a device in an implementation scenario may be distributed in the device in the implementation scenario according to the description of the implementation scenario, or may be located in one or more devices other than that in the present implementation scenario under corresponding modifications. The modules of the above implementation scenario may be combined into one module, or may be further divided into a plurality of sub-modules.

The above serial numbers in the present disclosure are only used for the description, and do not represent the advantages or disadvantages of the implementation scenarios.

The contents disclosed above only show a few specific implementation scenarios of the present disclosure; however, the present disclosure is not limited thereto, and any changes that would be made by a person skilled in the art should fall within the scope of protection of the present disclosure.

### INDUSTRIAL APPLICABILITY

The present disclosure realizes a simple structure, and can meet requirements of people for massage and health care during bathing, and at the same time, people can fully relax during the bathing process. The shower head allows the user to be massaged when taking a shower, while ensuring the reliability and safety of the use, hereby achieving the effects of relaxing the muscles and promoting blood circulation, wherein the user can obtain more comfortable bathing and massage experience, thus, the shower head has industrial applicability.

1. A shower head, comprising: an upper plate provided with water inlets, a water dispensing plate provided with water outflow openings, and a water outflow panel provided with water outflow nozzles, wherein the upper plate, the water dispensing plate and the water outflow panel are arranged successively from top to bottom;
the water dispensing plate is provided with an impeller, which is in rotatable connection with the water dispensing plate and configured to intermittently block the water outflow openings by way of rotation;
the impeller is provided with a blocking piece for blocking the water outflow openings;
each of the blocking piece has a fan-shaped cross-section;
the impeller and the blocking pieces are formed integrally; and
the water outflow openings are arranged in one-to-one correspondence with the water outflow nozzles.

2. The shower head according to claim 1, wherein the water dispensing plate comprises a bottom board, a first cylindrical side wall perpendicular to the bottom board, and a second cylindrical side wall arranged within the first cylindrical side wall;
shaft axes of the first cylindrical side wall and the second cylindrical side wall are collinear with each other, and the first cylindrical side wall and the second cylindrical side wall are both in fixed connection with the bottom board;
the water outflow openings pass through the bottom board perpendicularly, and are arranged between the first cylindrical side wall and the second cylindrical side wall; and
the impeller is provided with a through hole having a circular cross-section, wherein the through hole is in rotatable connection and in clearance fit with the second cylindrical side wall.

3. The shower head according to claim 1, wherein a plurality of blocking pieces are provided; and
the blocking pieces are spaced from each other and are distributed in a same plane.

4. The shower head according to claim 3, wherein the plurality of blocking pieces are in an array distribution around a rotation axis of the impeller.

5. The shower head according to claim 1, wherein the impeller is made of plastic by injection molding.

6. The shower head according to claim 1, wherein the water inlets pass through the upper plate, and are not perpendicular to a cross-section of the upper plate.

7. The shower head according to claim 1, wherein the water inlets are arranged in several groups.

8. The shower head according to claim 7, wherein the several groups of the water inlets are in an array distribution around the rotation axis of the impeller.

9. The shower head according to claim 7, wherein two water inlets are provided in each group, and the two water inlets are inclined in a same direction.

10. The shower head according to claim 9, wherein the two water inlets are distributed along a radial direction of the upper plate.

11. The shower head according to claim 1, wherein a plurality of water outflow openings are provided and are in an array distribution about the rotation axis of the impeller.

12. The shower head according to claim 11, wherein the water outflow openings are provided in a number of 8.

13. The shower head according to claim 11, wherein the water outflow openings are distributed on the water dispensing plate at an equal distance.

14. The shower head according to claim 11, wherein the water outflow nozzles are in number same as that of the water outflow openings.

15. The shower head according to claim 11, wherein positions of the water outflow openings respectively correspond to positions of the water outflow nozzles.

16. The shower head according to claim 1, wherein each of the water outflow nozzles is provided with a plurality of water outlets.

17. The shower head according to claim 16, wherein the plurality of water outlets are provided in a number of 3.

18. The shower head according to claim 16, wherein distances between adjacent water outlets on a same water outflow nozzle are equal to each other.

19. The shower head according to claim 2, wherein a plurality of blocking pieces are provided; and
the blocking pieces are spaced from each other and are distributed in a same plane.

20. The shower head according to claim 2, wherein the impeller is made of plastic by injection molding.
